(19) United States
(12) Patent Application Publication
(10) Pub. No.: US 2011/0156406 A1
(43) Pub. Date: Jun. 30, 2011

(54) Platform energy harvesting

(76) Inventors: Qing Ma, Saratoga, CA (US); Helia Naeimi, Santa Clara, CA (US)

(21) Appl. No.: 12/657,656

(22) Filed: Jan. 25, 2010

Related U.S. Application Data
(60) Provisional application No. 61/335,171, filed on Dec. 31, 2009.

(51) Int. Cl. F03G 7/08

(52) U.S. Cl. 290/1 A

(57) ABSTRACT

Presented herein are approaches for using mother boards and/or other masses, already in a platform

### RELATED APPLICATIONS

This application is related and claims priority to U.S. Provisional Patent Application Ser. No. 61/335,171 enitled, “PLATFORM ENERGY HARVESTING”, and which was filed on Dec. 31, 2009; this application is entirely incorporated by reference.

### TECHNICAL FIELD

The present invention relates generally to power sources and in particular, to energy harvesting approaches for portable computing platforms.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 shows a top view of a computing platform configured with a vibratory energy harvesting structure in accordance with some embodiments

FIG. 2 is a cross-sectional view of an electromagnetic implementation in accordance with some embodiments.

FIGS. 3A-3C show different piezoelectric energy harvesting (PEH) embodiments for use with computing platforms.

FIG. 4 is a block diagram of a computing platform including kinetic energy harvesting in accordance with some embodiments.

FIG. 5 shows an exemplary kinetic energy harvesting module suitable for use with the platform of FIG. 4 in accordance with some embodiments.

### DETAILED DESCRIPTION

Existing mobile platforms such as notebook computers, netbook computers, smart phones and other portable appliances are commonly subjected to relatively significant vibration. Presented herein are approaches for using mother boards and/or other masses, already in a platform, as the kinetic energy mass sources for generating electrical power using vibratory energy that is typically inherent to normal platform environments. Mother boards and other system components such as battery sub-systems, etc., typically have sufficient masses to serve as effective vibrating masses (mass source) for providing the mechanical energy to be converted into electrical power.

In some embodiments, mass sources within a platform housing can vibrate against the platform case, and the kinetic energy of such relative motion can be converted using, for example, electromagnetic or piezoelectric structures. In some embodiments, the vibration of the mother board may not constitute a reliability issue because the energy generating structure may also serve as a shock absorption mechanism.

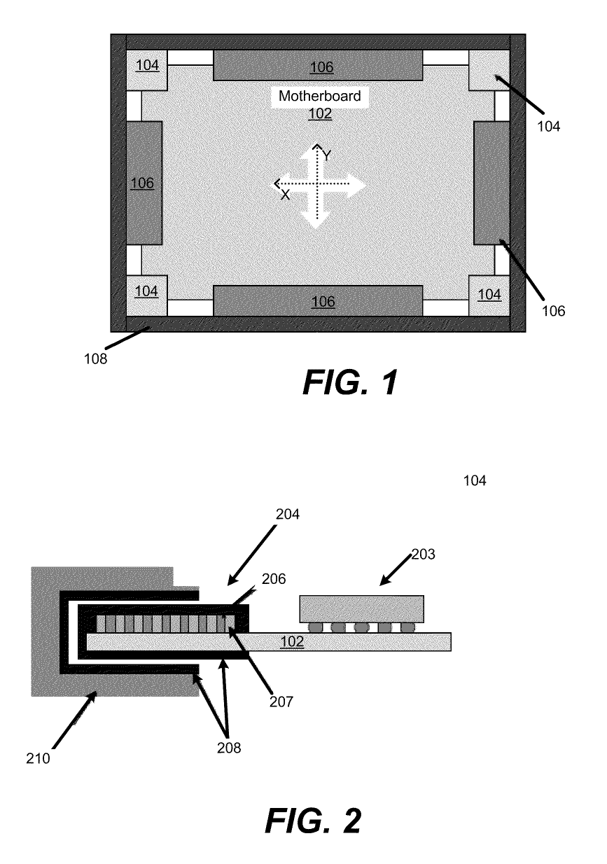

FIG. 1 shows a top view of a computing platform configured with a vibratory energy harvesting structure in accordance with some embodiments. Shown here is the platform mother board 102, elastic cushions 104 (e.g., compliant cushions for providing proper shock absorption), energy harvesting devices 106 (also referred to as kinetic power source “KPS”), and the platform housing case. The motherboard typically has mounted to it many, if not most, of the electrical components of a portable computing platform, although the battery module and display may constitute substantial masses not mounted to the motherboard. (It should be appreciated that the term. “motherboard” is used to connote a relatively planer structure in'a computing platform that has mounted to it one or more electronic modules and has sufficient mass to generate kinetic power including vibratory power as taught herein. it should also be appreciated that while a platform motherboard may serve well as a mass source, other platform structures may also suffice, alone, or in cooperation with a motherboard. For example, the battery module and/or display, e.g., a clam shell hinged display, when closed) may be used, alone or in cooperation with other platform masses, may be used as mass sources.

The mother board (or other platform structure or structures with sufficient mass) can be used as a mass source or mass sources. In FIG. 1, the motherboard, itself, is used. The motherboard vibrates laterally (in the X-Y plane) relative to the case against the energy harvesting devices 106, causing them to generate electrical charge. The energy harvesting devices 106 may be implemented with any suitable devices that can convert motion into electrical charge. Such devices, as presented herein, include but are not limited to electro-magnetic and piezoelectric structures.

FIG. 2 is a cross-sectional view of an electromagnetic implementation in accordance with some embodiments. The depicted electromagnetic device 204 comprises a coil comprising copper conductor turns 207 and a core 206, e.g., magnetic-material core. In this figure, a cross-section of the coil is shown. It is positioned to receive a magnetic field produced by one or more permanent magnets 210, positioned relative to the coil(s) so that as the motherboard 102 moves laterally, the coil is exposed to a changing magnetic field, which generates charge. In this figure, the motherboard moves left-right and in-out of the page ((back and forth in either of the X-Y directions and/or a combination thereof),

The EMEH (electro-magnetic energy harvesting) device 204 has anti-wear coatings 208 to enable the coil structure, which is atop the motherboard in this embodiment, to move within the permanent magnet 210 structure without excessive wear. Any suitable material could be used. Moreover, any suitable mechanism can be used to mount the motherboard so that it can vibrate without causing excessive damage to the EMEH device(s), to the platform housing, and to the motherboard, and its constituent components (e.g., mounted chip 203).

Not shown but also included is electrical structure, e.g., connections, conductors, etc to couple the charge, generated by the EMEH 204, to a charge collection device such as to a platform power module discussed below.

It should be appreciated that while coils mounted atop a motherboard are shown, any suitable electromagnetic device(s) may be employed. Different magnetic configurations, with appropriately disposed coils, may be used. Many small coils or several larger coils could be used. it may be advantageous to employ coil cores to more efficiently channel magnetic flux toward the pertinent coils surface but depending on particular design concerns, other constructions could be used.

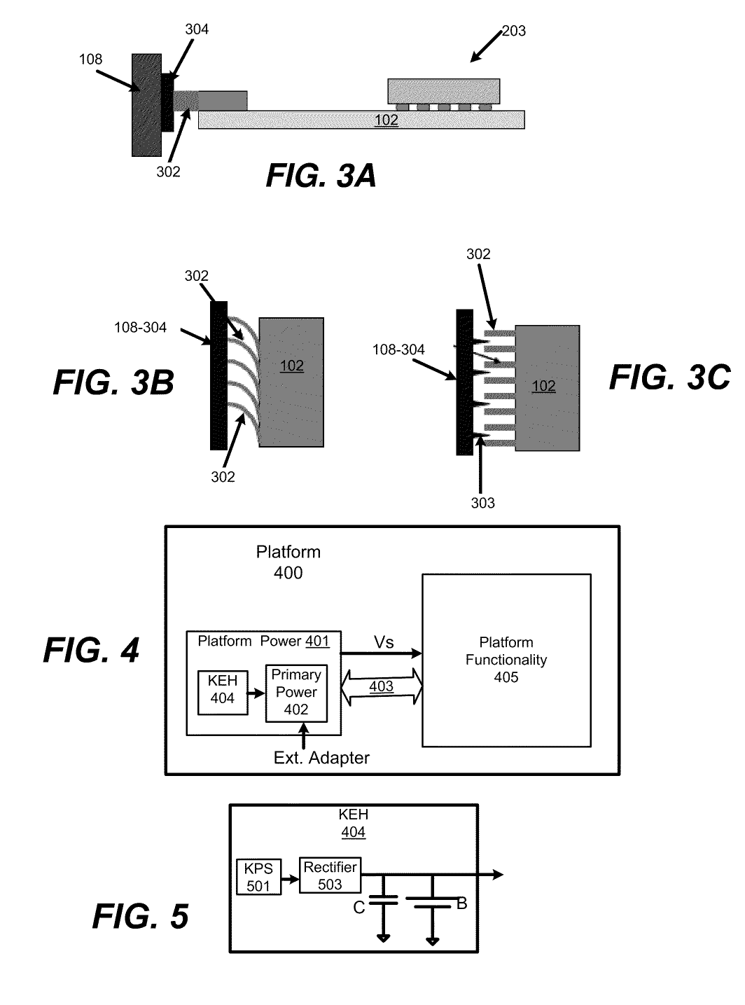

FIGS. 3A to 3C show different piezoelectric energy harvesting (PEH) embodiments for use with computing platforms. Piezoelectricity is the ability of some materials (notably crystals and certain ceramics) to generate an electric field or electric potential in response to applied mechanical stress. The effect is closely related to a change of polarization density within the material's volume. If the material is not short-circuited, the applied stress induces a voltage across the material. Three types of potentially useful piezoelectric devices, suitable for energy harvesting devices discussed herein, include monolithic piezo-ceramic materials (e.g., lead-zirconate-titanate), bimorph quick pack actuators and macro fiber composites. Through experimentation by others, it has been estimated these devices can be effective for electrical charge production. (See Sodano et al., Comparison of Piezoelectric Energy Harvesting Devices for Recharging Batteries, LA-UR-04-5720, Journal of Intelligent Material Systems and Structures, 16(10), 799-807, 2005).

FIG. 3A shows a cross-sectional view of a PEH device with piezoelectric beams 302 mounted to the surface of the motherboard 102. FIG. 3B shows a top view of the apparatus. When the motherboard 102 vibrates against a contact member 304 from the case 108, the piezoelectric beams bend and produce electrical charge, which is conveyed to a storage device via conductors and contacts (not shown). In this implementation, the device uses the vibrating frequency of the board to move the beams against the edge of the case 108/contact surface 304.

A deviation of this approach is shown in FIG. 3C. Here, tines 303 are incorporated into the case contact edges. They allow for the torque exerted onto the beams to be varied, in accordance with design considerations. In some embodiments, they may be used to improve energy conversion efficiency.

Through experimental simulation, it has been estimated that a reasonable amount of electrical power may be harvested with devices as taught herein. The generated power may be:

P=(¼π)(m·ωₒ³·χₒ²)

where m is the source mass, χₒ, is the average vibratory displacement per vibration cycle, and ωₒ is the resonant frequency of the moving part of the EH device. Assume a typical platform source mass, such as a motherboard with electronics and battery packs, has a mass of 80 g. Also assume the mass can move a maximum of 5 mm. The generated power for walking and for shaking may be estimated. For walking, assume an acceleration of 0.3 g and a frequency of 1.8 Hz. With these values, an estimated amount of 230 uW may be generated. For shaking, with an acceleration of 1.3 g and a frequency of 3 Hz, an estimated power of about 1064 uW may be obtained. These, of course, are very rough estimates, depending highly on the particular mechanical implementation and utilized EH device type.

FIG. 4 is a block diagram of a computing platform amenable for kinetic energy harvesting (KEH) as taught herein. Shown in this figure is a platform 400 comprising electricity consuming functionality 405 and a platform power source 401 to provide it with power. The platform power source 401 provides it with a voltage supply (Vs) and communicates with the functional circuits via a link 403. The platform power 401 has a primary power source 402 and a kinetic energy harvesting (KEH) source 404.

The platform could be any portable electronic device such as a notebook computer, a netbook computer, a smart phone, or any other portable electronic appliance. The platform functionality 405 corresponds to the various functional modules, e.g., motherboard with main processor chip or SoC, display, etc. The primary power block 402 corresponds to a battery module including any battery charge circuits and/or platform power management circuits for controlling power provided to the platform functionality 405, as well as charging of the battery within the primary power block 402. For example, it may have circuitry to control power from a “plugged in” external adapter to be provided to the platform, as well as to the platform for it's real-time power needs. It may also have circuitry to control the transfer of energy from the KEH module 404 into one or more cells of the primary power block 402.

The KEH 404 is coupled to the primary power block 402 to provide it with charge, either in real time as it is being accumulated or alternatively, at different times when enough charge has accumulated within the KEH module for efficient transfer into the primary power module 402. The KEH may comprise any combination of kinetic power source devices (such as electro-magnetic or piezoelectric devices, as discussed herein) and in some cases, energy storage devices such as capacitors and/or battery cells.

FIG. 5 shows an exemplary KEH module 404 in accordance with some embodiments. It comprises a kinetic power source (KPS) 501, a rectifier 503, a capacitor C, and a battery B, coupled as shown. The rectifier may be implemented with any suitable rectifier, such as a half-wave or full wave rectifier, using any suitable components such as diodes. Devices such as diodes with minimal forward bias drops may be desired. In operation, charge will flow into the capacitor to charge it through the rectifier. When a sufficient voltage is attained in the capacitor, depending on the minimum charging voltage for the battery, it charges the battery. The capacitor acts as a buffer to efficiently accumulate charge generated by the KPS 501 in the short term, while the battery serves as a larger, more stable charge storing reservoir (e.g., the capacitor may be more likely to leak away charge over time). It should be appreciated that embodiments using only one or more capacitors, or batteries, alone could be used. Some capacitors may be well suited for storing relatively large amounts of charge and at the same time, some batteries may be efficient for collecting small amounts of charge generated by the KPS. Along these lines, the battery (B) in the KEH 404 may be the same battery or battery type as used in the primary power module 402, or a different type of battery could be used.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography), mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
a computing platform having one or more energy harvesting devices to generate electrical charge responsive to the motion of one or more mass sources of the platform.

2. The apparatus of claim 1, in which the one or more mass sources comprise a motherboard.

3. The apparatus of claim 2, in which the one or more energy harvesting devices are mechanically linked to the motherboard to move and thereby generate electrical energy from the energy harvesting devices.

4. The apparatus of claim 3, in which the one or more energy harvesting devices comprises electromechanical devices.

5. The apparatus of claim 4, in which the electromechanical energy harvesting devices comprise coils mounted to the motherboard.

6. The apparatus of claim 5, in which the electromechanical devices comprise a permanent magnet mounted to an interior housing portion.

7. The apparatus of claim 3, in which the one or more energy harvesting devices comprises piezoelectric devices.

8. The apparatus of claim 7, in which the one or more piezoelectric devices comprise beams made from piezoelectric material.

9. The apparatus of claim 8, in which the beams are mounted to the motherboard.

10. The apparatus of claim 1, in which the computing platform is a portable tablet computer.
